(19) United States
(12) Patent Application Publication
(10) Pub. No.: US 2017/0343436 A1
(43) Pub. Date: Nov. 30, 2017

(54) MULTI-ANGLE PRESSURE SENSING DEVICE

(71) Applicant: HON HAI PRECISION INDUSTRY CO., LTD., New Taipei (TW)

(72) Inventors: TSUNG-JU WU, New Taipei (TW); JEN-TSORNG CHANG, Tu-Cheng (TW)

(21) Appl. No.: 15/498,598

(22) Filed: Apr. 27, 2017

(30) Foreign Application Priority Data
May 30, 2016 (CN) 201610366908.3

(51) Int. Cl. G01L 5/16; G01L 1/26; G01L 1/16

(52) U.S. Cl. CPC G01L 5/167; G01L 1/16; G01L 1/26

(57) ABSTRACT

A device able to sense pressure from multiple directions includes a substrate and an elastic member comprising a bottom end and a touch end. The bottom end is arranged on the substrate, and the touch end is configured to receive an external force. A group of pressure detecting units are arranged on the touch end, each pressure detecting unit is a curved shape and comprises a first end and a second end, the first end being fixed on the substrate, and the second end is fixed with the elastic member. Distances between each first end and the bottom end are same, and a first signal processing unit is electrically connected with the at least two detecting units.

The subject matter herein generally relates to a multi-angle pressure sensing device.

### BACKGROUND

In medical and robotics fields, a sensing device can detect a force. However, typically a sensing device is only able to detect pressure in one direction.

### BRIEF DESCRIPTION OF THE DRAWINGS

Implementations of the present technology will now be described, by way of example only, with reference to the attached figures.

FIG. 1 is an isometric view of a multi-angle pressure sensing device in accordance with a first exemplary embodiment.

FIG. 2 is a top view of the sensing device in FIG. 1.

FIG. 3 is a bottom view of the sensing device of FIG. 1.

### DETAILED DESCRIPTION

It will be appreciated that for simplicity and clarity of illustration, where appropriate, reference numerals have been repeated among the different figures to indicate corresponding or analogous elements. In addition, numerous specific details are set forth in order to provide a thorough understanding of the embodiments described herein. However, it will be understood by those of ordinary skill in the art that the embodiments described herein can be practiced without these specific details. In other instances, methods, procedures, and components have not been described in detail so as not to obscure the related relevant feature being described. Also, the description is not to be considered as limiting the scope of the embodiments described herein. The drawings are not necessarily to scale and the proportions of certain parts may be exaggerated to better illustrate details and features of the present disclosure.

Several definitions that apply throughout this disclosure will now be presented.

The term “substantially” is defined to be essentially conforming to the particular dimension, shape, or other feature that the term modifies, such that the component need not be exact. For example, “substantially cylindrical” means that the object resembles a cylinder, but can have one or more deviations from a true cylinder. The term “comprising,” when utilized, means “including, but not necessarily limited to”; it specifically indicates open-ended inclusion or membership in the so-described combination, group, series, and the like. The references “a plurality of” and “a number of” mean “at least two.”

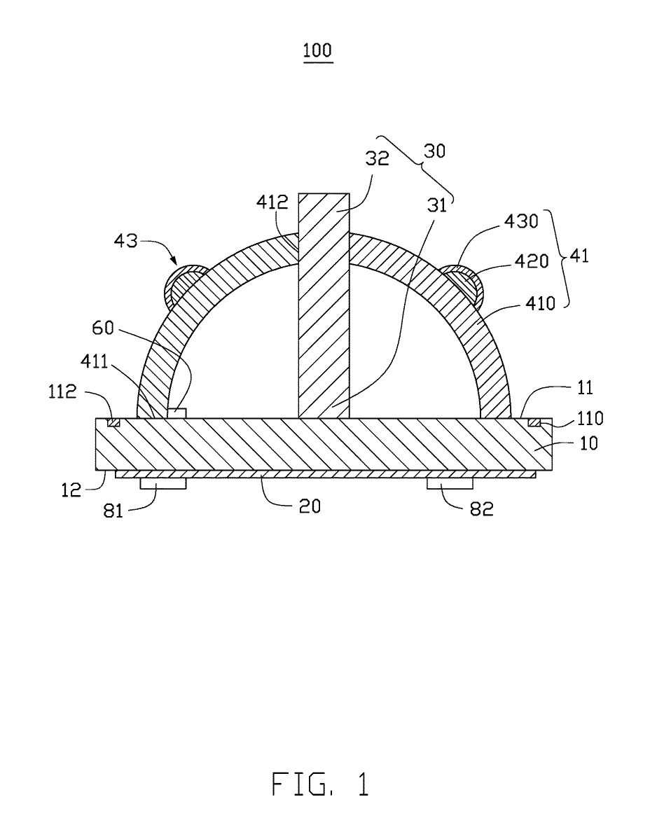

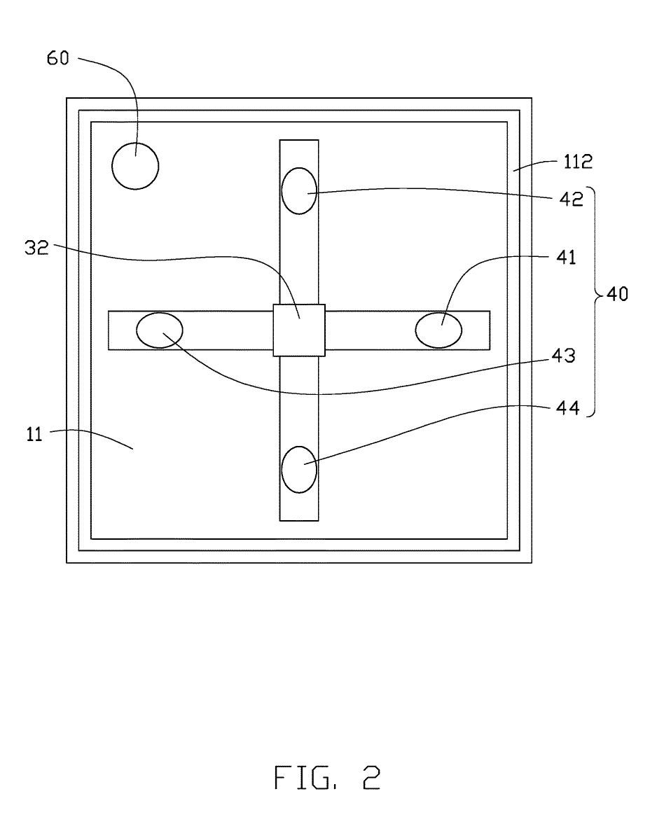

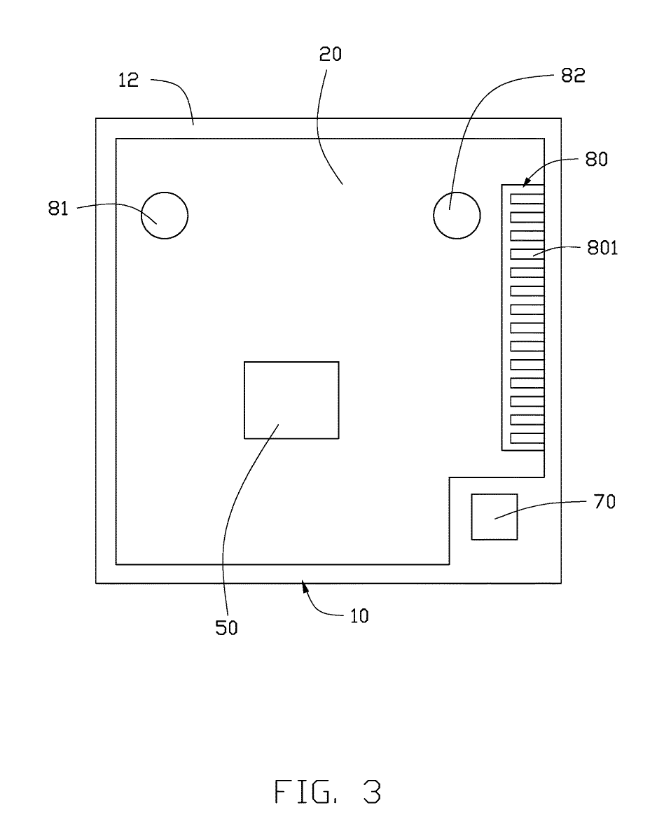

FIG. 1-3 illustrate a multi-angle pressure sensing device 100 according to a first exemplary embodiment. The multi-angle pressure sensing device 100 includes a substrate 10, a printed circuit board 20, an elastic member 30, a group of pressure detecting units 40, a first signal processing unit 50, an ultrasonic sensor 60, a second signal processing unit 70, a connection port 80, a first control switch 81, and a second control switch 82.

The substrate 10 includes a top surface 11 and a bottom surface 12 opposite to the top surface 11. The top surface 11 of the substrate 10 comprises a ring-shaped groove 110 being arranged adjacent an edge in the substrate 10, the groove 110 is configured to receive a signal line 112 electrically connecting the ultrasonic sensor 60 and the second signal processing unit 70.

The printed circuit board 20 is installed on the bottom surface 12 of the substrate 10 and electrically connected with the group of pressure detecting units 40, the first signal processing unit 50, the ultrasonic sensor 60, the second signal processing unit 70, and the connection port 80.

The elastic member 30 is substantially a solid rubber part, and includes a bottom end 31 and a touch end 32 opposite to the bottom end 31. The bottom end 31 is bonded on the top surface 11 of the substrate 10. The touch end 32 is configured to receive external forces. That is, the elastic member 30 is used as a force transfer member, such that when the touch end 32 receives an external force, the solid elastic member 30 elastically deforms, and the pressure detecting unit 40 detect the elastic deformation of the elastic member 30. In an alternative embodiment, the solid elastic member 30 can be replaced by a coil spring.

The group of pressure detecting units 40 includes four pressure detecting units 41, 42, 43, and 44. The first pressure detecting unit 41 and the third pressure detecting unit 43 are arranged on opposite sides of the elastic member 30. The first pressure detecting unit 41 and the third pressure detecting unit 43 are together configured to detect a force along X axis and Z axis. The second pressure detecting unit 42 and the fourth pressure detecting unit 44 are arranged on opposites sides of elastic member 30. The second pressure detecting unit 42 and the fourth pressure detecting unit 44 are together configured to detect a force along Y axis and Z axis.

Each pressure detecting unit 40 includes a first electrode sheet 410, a piezoelectric sheet 420 deposited on the first electrode sheet 410, and a second electrode sheet 430 formed on the piezoelectric sheet 420.

In the illustrated embodiment, the first electrode sheet 410 is a curved shape and made from a stainless steel material, to avoid force concentration and metal fatigue. A thickness of the first electrode sheet 410 is about 30 micrometers. Each first electrode sheet 410 includes a first end 411 and a second end 412. The first end 411 is fixed on the top surface of the substrate 10, the second end 412 is fixed to the elastic member 30. A height between each second end 412 and the end 32 is the same, and a distance between each first end 411 and the bottom end 31 is same. The four first ends 411 of the four pressure detecting units 41, 42, 43 and 44 locate at a same circle. A connecting line between the two first ends 411 of the pressure detecting units 41 and 43 is perpendicular to a connecting line between the two first ends 411 of pressure detecting units 42 and 44.

The piezoelectric sheet 420 is made from a material which can be selected from the group consisting of single crystal materials, polymer materials, film materials, ceramic materials, composite materials, and any combination thereof. For example, can be pbzrtio3, BaTiO3, ZnO, PVDF, quartz material, and so on.

The first signal processing unit 50 is installed on the printed circuit board 20 and electrically connected with the pressure detecting units 41, 42, 43, and 44. The first signal processing unit 50 includes a memory containing a database of relationships between a flexible deformation, a voltage change with the deformation, and force equivalent to the voltage change. The first signal processing unit 50 is configured to receive a voltage signal from the pressure detecting units 41, 42, 43, 44, detect a force according to the database, and then output a first output signal.

The ultrasonic sensor 60 and the second signal processing unit 70 are embedded on the substrate 10. The ultrasonic sensor 60 is configured to emit an ultrasonic wave signal. When the wave signal encounters an obstacle, the wave signal is reflected and received by the second signal processing unit 70.

The second signal processing unit 70 is configured to calculate a distance between the ultrasonic sensor 60 and the obstacle, and thus output a second output signal. For example, the second output signal may be an instruction to drive a driver mounted inside a product containing with the multi-angle pressure sensing device 100 to move forward, or backward, or change direction.

The connecting port 80 is electrically connected to the first signal processing unit 50 and the second signal processing module 70. The connecting port 80 includes a plurality of edge connectors (e.g., gold fingers 801). The connecting port 80 is configured for receiving first output signal from the first signal processing unit 50 and second signal from the second signal processing unit 70 and output the first output signal and the second output signal to an external electronic equipment. Thereby, the connecting port 80 is configured to realize a data exchange between the multi-angle pressure sensing device 100 and external electronic equipment.

In an alternative embodiment, the pressure detecting unit 40 only includes two pressure detecting units, such as the pressure detecting unit 41 and 42. The two first ends 411 of the two pressure detecting units 41 and 42 locate at a same circle. A connecting line between a center of the circle and one first end 411 of the corresponding pressure detecting unit 41 is perpendicular to a connecting line between a center of the circle and the other first end 411 of the corresponding pressure detecting unit 42.

Both the first control switch 81 and the second control switch 82 are mounted on the printed circuit board 20. The first control switch 81 is electrically connected to the group of pressure detecting units 40 and the first signal processing unit 50, and the first control switch 81 is configured to control the group of pressure detecting units 40 individually. The second control switch 82 is electrically connected to the ultrasonic wave generating device 50 and the second signal processing unit 60, and the second control switch 82 is configured to control the ultrasonic wave generating device 50. That is, the first control switch 81 and the second control switch 82 allow manual control of the multi-angle pressure sensing device 100. When only multi-angle force is to be detected, the second control switch 82 is turned off. When only a distance between the multi-angle pressure sensing device 100 and an obstacle is to be measured, the first control switch 81 is turned off.

When the multi-angle pressure sensing device 100 is in use, the multi-angle pressure sensing device 100 can be mounted in a robot, medical devices, toys, and other products. The ultrasonic sensor 60 is configured to sense a distance between a product with the multi-angle pressure sensing device 100 and an obstacle. When the touch end 32 is subjected to an external force, the ultrasonic sensor 60 stops working, and the pressure detecting units 40 sense the external force and the second signal processing unit 70 calculates the external force.

When the touch end 32 is subjected to an external force, the elastic member 30 will elastically deform. Since one end of the pressure detecting unit 40 is fixed with the elastic member 30, the pressure detecting unit 40 will experience the elastic deformation of the elastic member 30, and the piezoelectric sheet 420 will generate a voltage according to the pressure. The first signal processing unit 50 receives the voltage change from the piezoelectric sheet 420 and calculates the external force.

A force along X axis, Y axis and Z axis is able to calculated as follows.

The first pressure detecting unit 41 includes a first piezoelectric sheet 420a, the third pressure detecting unit 43 includes a third piezoelectric sheet 420c. When the elastic member 30 is experienced an external force, the first piezoelectric sheet 420a generates a deformation component along X axis and Z axis, respectively. The third piezoelectric sheet 420c also generates a deformation component along X axis and Z axis, respectively. A first force corresponding to the X axis deformation component detect by the first piezoelectric sheet 420a is calculated according to the database contained in the first signal processing unit 50, and a third force corresponding to the X axis deformation component detected by the third piezoelectric sheet 420c is calculated according to the database contained in the first signal processing unit 50. Therefore, an external force along X axis is an average value of the first force along X axis and the third force along X axis.

Similarly, a first force corresponding to the Z axis deformation component detected by the first piezoelectric sheet 420a is calculated according to the database contained in the first signal processing unit 50, and a third force corresponding to the Z axis deformation component detect by the third piezoelectric sheet 420c is calculated according to the database contained in the first signal processing unit 50. Therefore, an external force along Z axis is an average value of the first force along Z axis and the third force along Z axis.

The second pressure detecting units 42 includes a second piezoelectric sheet 420b, the fourth pressure detecting units 44 includes a third piezoelectric sheet 420d. When the elastic member 30 is experienced an external force, the second piezoelectric sheet 420b generates a deformation component along Y axis and Z axis, respectively. The fourth piezoelectric sheet 420d also generates a deformation component along Y axis and Z axis, respectively. A second force corresponding to the Y axis deformation component detect by the second piezoelectric sheet 420b is calculated according to the database contained in the first signal processing unit 50, and a fourth force corresponding to the Y axis deformation component detected by the fourth piezoelectric sheet 420d is calculated according to the database contained in the first signal processing unit 50. An external force along Y axis is an average value of the second force along Y axis and the fourth force along Y axis.

Of cause, an external force along Z axis is also can be calculated using an average value of the second force along Z axis and the fourth force along Z axis. In this way, the external force in multiple directions is calculated.

The embodiments shown and described above are only examples. Therefore, many such details are neither shown nor described. Even though numerous characteristics and advantages of the present technology have been set forth in the foregoing description, together with details of the structure and function of the present disclosure, the disclosure is illustrative only, and changes may be made in the detail, including in matters of shape, size, and arrangement of the parts within the principles of the present disclosure, up to and including the full extent established by the broad general meaning of the terms used in the claims. It will therefore be appreciated that the embodiments described above may be modified within the scope of the claims.

What is claimed is:

1. A multi-angle pressure sensing device comprising:
a substrate comprising a top surface and a bottom surface;
an elastic member comprising a bottom end and a touch end opposite to the bottom end, the bottom end being arranged on the top surface, the touch end being configured to receive an external force;
a group of pressure detecting units, each pressure detecting unit comprising a first electrode sheet and a piezoelectric sheet formed on the first electrode, each first electrode sheet being in a curved shape and comprising a first end and a second end opposite to the second end, the first end being fixed on the top surface, and the second end being fixed with the elastic member, and a height between each second end and the touch end is same with each other, and a distance between each first end and the bottom end is same with each, and
a first signal processing unit electrically connected with the group of pressure detecting units, wherein when the touch end receives a force, each piezoelectric sheet is able to produce a flexible deformation, and output a voltage signal corresponding to the flexible deformation, and the first signal processing unit is configured to receive the voltage signal and calculate the external force according to the voltage signal.

2. The multi-angle pressure sensing device of claim 1, wherein each pressure detecting unit further comprises a second electrode sheet formed on the piezoelectric sheet, both the first electrode sheet and the second electrode sheet are electrically connected with the piezoelectric sheet.

3. The multi-angle pressure sensing device of claim 1, wherein the elastic member is a solid cylinder

4. The multi-angle pressure sensing device of claim 3, wherein the elastic member is and made from rubber.

5. The multi-angle pressure sensing device of claim 3, wherein the elastic member is a coil spring

6. The multi-angle pressure sensing device of claim 2, wherein the sensing device further comprises a printed circuit board arranged on the bottom surface of the substrate and electrically connected with the group of pressure detecting units.

7. The multi-angle pressure sensing device of claim 1, wherein the group of pressure detecting units comprises four pressure detecting units, a connecting line between a center of the circle and one first end of the corresponding pressure detecting unit is perpendicular to a connecting line between a center of the circle and the other first end of the corresponding pressure detecting unit.

8. The multi-angle pressure sensing device of claim 1, wherein the group of pressure detecting units comprises two pressure detecting units, a connecting line between the two first ends of the opposite pressure detecting units is perpendicular to a connecting line between the other opposite two first ends of pressure detecting units.

9. The multi-angle pressure sensing device of claim 6, wherein the multi-angle pressure sensing device further comprises an ultrasonic sensor and a second processing unit mounted on the printed circuit board, the ultrasonic sensor is configured to emit an ultrasonic wave signal, and the second signal processing unit configured to receiving the ultrasonic wave signal, and detect a distance between the multi-angle pressure sensing device and an obstacle according to the ultrasonic wave signal.

10. The multi-angle pressure sensing device of claim 9, wherein the multi-angle pressure sensing device further comprises a connection port, and the connection port is electrically connection with the first signal processing unit and the second signal processing unit.

11. The multi-angle pressure sensing device of claim 10, wherein the connecting port comprises a plurality of gold fingers and configured for receiving a first output signal from the first signal processing unit and a second output signal from the second signal processing unit and output the first output signal and the second output signal to an external electronic equipment.

12. The multi-angle pressure sensing device of claim 6, wherein the substrate comprises a ring-shaped groove arranging adjacent an edge therein, and the groove is configured to receive an electrical connection line between the ultrasonic sensor and the second signal processing unit.

13. The multi-angle pressure sensing device of claim 7, wherein the first electrode sheet is made from a stainless steel material.

14. The multi-angle pressure sensing device of claim 13, wherein a thickness of the first electrode sheet is about 30 micrometers.

15. The multi-angle pressure sensing device of claim 1, wherein the multi-angle pressure sensing device further comprises a first control switch, the first control switch is electrically connected to the group of pressure detecting units and the first signal processing unit, and the first control switch is configured to control the group of pressure detecting units.

16. The multi-angle pressure sensing device of claim 1, wherein the multi-angle pressure sensing device further comprises a second control switch, the second control switch is electrically connected to the ultrasonic wave generating device and the second signal processing unit, and the second control switch is configured to control the ultrasonic wave generating device.
